(19) United States
(12) Patent Application Publication
(10) Pub. No.: US 2024/0062590 A1
(43) Pub. Date: Feb. 22, 2024

(54) METHOD FOR EXECUTING A TEST DRIVE WITH AT LEAST ONE TEST VEHICLE

(71) Applicant: AVL List GmbH, Graz (AT)

(72) Inventors: Philipp Quinz, Graz (AT); Marijn Hollander, Graz (AT); Rainer Vögl, Kumberg (AT)

(21) Appl. No.: 18/269,196

(22) PCT Filed: Dec. 22, 2021
(86) PCT No.: PCT/AT2021/060484

§ 371 Date: Jun. 22, 2023

(30) Foreign Application Priority Data
Dec. 23, 2020 (AT) A 51134/2020

(51) Int. Cl. G07C 5/02; G01M 17/007

(52) U.S. Cl. CPC G07C 5/02; G01M 17/007

(57) ABSTRACT

In order to simplify the execution of test drives with a test vehicle which is controlled by a test driver so as to complete a test case, according to the invention, for each test case (TFj) a start condition (SBj) is defined on the basis of at least one sensor signal (S) of a vehicle sensor of the test vehicle and stored in the memory unit together with the associated test case (TFj), wherein each start condition (SBj) defines a particular vehicle state, at least one sensor signal (S) that represents a current vehicle state is recorded by at least one vehicle sensor during the test drive, and the at least one sensor signal (S) is transmitted to a test unit, the test unit reads out the start condition (SBj) of at least one stored test case (TFj) from the memory unit and, during the test drive, the test unit checks whether the vehicle state stored for the read-out start condition (SBj) and the current vehicle state represented by the recorded sensor signal (S) match, and, if they match, the test driver completes the test case (TFj) assigned to the read-out start condition (SBj), in that said test case (TFj) is started, and the test driver is provided with the test steps (TSn) defined in this test case (TFj) for attention, and the test driver performs these test steps (TSn).

The present invention relates to a method for executing a test drive with at least one test vehicle, wherein the test vehicle is moved by a test driver along a travel route, wherein a plurality of test cases are stored in a memory unit, and each test case is defined as a sequence of test steps which are to be executed by the test driver while carrying out the test case, and at least one of these stored test cases is completed by the test driver during the test drive. The invention also relates to an arrangement for executing such a test drive.

Although, in the development of vehicles in various development stages, tests on the vehicle or on components of the vehicle are executed on test benches, real test drives with the vehicle on roads also still play an important role. Such test drives are used primarily in late development stages and for particular tests that cannot be executed or cannot be executed satisfactorily on test benches. One example of this is tests in connection with modern vehicle assistance systems. Vehicle assistance systems intervene partially autonomously or autonomously in the drive, control, or signaling devices of the vehicle in order to avoid or mitigate dangerous situations, or to warn the driver of such critical situations by suitable human-machine interfaces. A whole range of vehicle sensors, both driving state sensors and environment sensors, are usually installed in modern vehicles, which sensors detect a specific driving state and/or the surroundings of the vehicle. A driving state sensor detects, for example, the driving dynamics of the vehicle, e.g., travel speed, accelerations, yaw rates, wheel speeds, etc., or drive values, e.g., engine speed, drive torque (also at different points of the drive train). Environmental sensors detect the surroundings of the vehicle within the detection range of the sensors. Examples of environment sensors are an ultrasonic sensor, radar, lidar, camera, rain sensor, light sensor, infrared sensor, etc.

The detected sensor signals of the vehicle sensors are processed in vehicle assistance systems and other control devices of the vehicle. The sensor signals can also be transmitted by a vehicle sensor via a vehicle bus and read from the vehicle bus—for example, by a control unit or vehicle assistance system. Examples of vehicle assistance systems that use environment sensors (and possibly also driving state sensors) are parking sensors, lane change assistants, automatic distance alert systems, cruise control, adaptive cruise control, blind spot monitoring systems, lane departure warning systems, traffic sign recognition systems, emergency braking assistants, emergency brake systems for pedestrian protection, etc. Examples of vehicle assistance systems that use driving state sensors are anti-lock braking systems, driving dynamics control systems, traction control systems, etc. The testing of such vehicle assistance systems is quite complex in practice.

For tests of vehicle assistance systems, test situations must be generated with a test vehicle, which result in a response of a specific vehicle assistance system. For this purpose, several test vehicles are often used on a test route, which are controlled by test drivers, so that certain traffic situations which cause a vehicle assistance system to respond are provoked. This is a very complex and expensive process because experienced test drivers are required for this purpose, and a test route is required for a long period of time. During the execution of the tests, certain vehicle signals are recorded and evaluated (online or offline). Often, the vehicle signals can be evaluated only offline, after the test drive has been executed, and it is checked whether a test has been executed correctly at all and was successfully completed.

However, other tests on vehicles apart from vehicle assistance systems are also conceivable, which depend upon certain driving states and/or environmental conditions in the surroundings of the vehicle. One example could be the testing of the exhaust gas emissions when the vehicle is started from a standstill or during uphill travel, or testing of an electric traction battery in certain driving states or environmental conditions.

To support a driver when executing test drives with a test vehicle, systems have already become known which give the driver driving instructions during the test in order to complete a certain test case. For this purpose, the driver selects a certain test case consisting of defined test steps from a number of available test cases. After starting the selected test case, the test steps of the test case are specified to the driver, who implements these test steps using the vehicle. Such systems are found, for example, in US 2010/0079301 A1 or EP 3 644 148 A1. However, the implementation of such a test in real road traffic is difficult because the surroundings of the vehicle, and in particular the traffic situation, cannot be controlled during the execution of the test, or must be simulated in a complicated manner by another test vehicle. Tests of vehicle assistance systems in particular are thus difficult or even impossible to implement.

In DE 10 2006 021 357 A1, the driver receives driving instructions based upon a current position of the vehicle, which is determined by means of GPS, for example. It is thus to be possible to better reproduce a test run, since the driver receives the same driving instruction at the same position. Certain tests, and in particular those which take into account the surroundings of the vehicle, such as in connection with vehicle assistance systems, however, cannot thus be realized.

It is an object of the present invention to simplify the execution of test drives with a test vehicle, which is controlled by a test driver for completing a test case.

This object is achieved by the features of the independent claims. The method according to the invention makes it possible, during a test drive, to detect, based upon a sensor signal of a vehicle sensor, whether a stored test case is possible. If a test case is possible, the test case is started, and the test steps stored with the test case are provided to the test driver for attention (acoustically, optically, tactilely), who can then execute said test steps. The test driver therefore does not have to worry about whether a start condition of a test case is met, but can simply execute the test drive until a start condition is met. In particular, it is thus very easy to identify, during the test drive, test cases for which another road user is necessary, without having to simulate this other road user by means of a second test vehicle in the course of executing the test. Instead, the real road traffic is used, and it is checked whether, due to the current traffic situation, which can be detected, for example, by means of an environment sensor, and/or on the basis of a current driving state, which can be detected, for example, via a driving state sensor, a certain test case results which can be carried out. The selection of the test cases can thus be considerably simplified.

Advantageously, the test unit reads out the start conditions of several stored test cases from the memory unit and checks, during the test drive, whether one of the vehicle states stored for those read out as start conditions and the current vehicle state represented by the sensor signal match. In the case of a match, the test driver completes the test case associated with this start condition, in that this test case is started, and the test steps defined in this test case are provided to the test driver for attention, and the test driver carries out these test steps. In this way, several test cases can be monitored at the same time with regard to their start condition. As soon as a start condition is met, this test case can be executed.

The test case can be automatically started by the test unit, which enables particularly simple execution of the test drive. Alternatively, the test case can be proposed to the test driver by the test unit for execution, and the test driver starts the test case. This is also possible if several test cases are monitored at the same time by the test unit as to their occurrence, by means of the associated start conditions. The test driver preferably receives the information via the user interface and can decide himself whether or not he wishes to carry out the possible test case. The test driver thus has more control over the test drive. Of course, combinations of these two options are also conceivable. For example, certain test cases can be started automatically, and others are proposed to the test driver, which can be configured in the test unit.

Advantageously, a completed test case, after completion or after a predetermined multiple completion, is deleted from the plurality of test cases in the memory unit. This reduces the effort for the test unit to detect test cases. At the same time, however, it can also be indicated to the test driver which test cases have not yet been completed, and the test driver can steer the test vehicle into such an environment where such not yet completed test cases occur, or the test driver can bring the test vehicle into a vehicle state in which such test cases occur. This information on the surroundings or on the vehicle state can also be proposed to the test driver by the test unit—for example, via the user interface.

The test unit can also be arranged in a test center, which is in data connection with the vehicle. This makes it possible to carry out the evaluation of the test cases in the test center. This also makes it possible to execute test drives in accordance with the invention with several test vehicles simultaneously, in that further test vehicles are moved by a further test driver along a travel route, and the further test vehicles are in data connection with the test unit of the test center. The test unit in the test center monitors the stored start conditions as to whether a test case is possible using one of the test vehicles. This test case can then be executed using this test vehicle. The procedure for this is as described above or in the claims. This makes it possible to operate a test fleet consisting of several test vehicles. Thus, the time for executing a test drive with a plurality of test cases can be significantly reduced. The test center can also specifically instruct the test vehicles, or the test drivers thereof, to seek specific driving environments or to establish vehicle states in order to selectively control the test coverage with test cases and to prevent unnecessarily repeated execution of test cases.

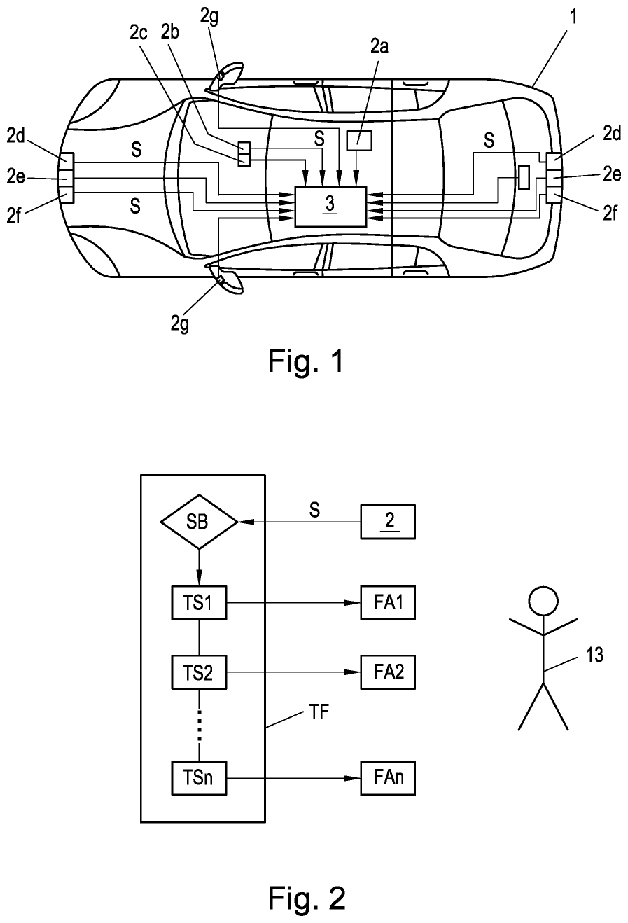

The present invention is described in greater detail below with reference to FIGS. 1 through 6, which show schematic and non-limiting advantageous embodiments of the invention by way of example. In the figures:

FIG. 1 shows a test vehicle with vehicle sensors,

FIG. 2 shows the structure of a test case with driving instructions,

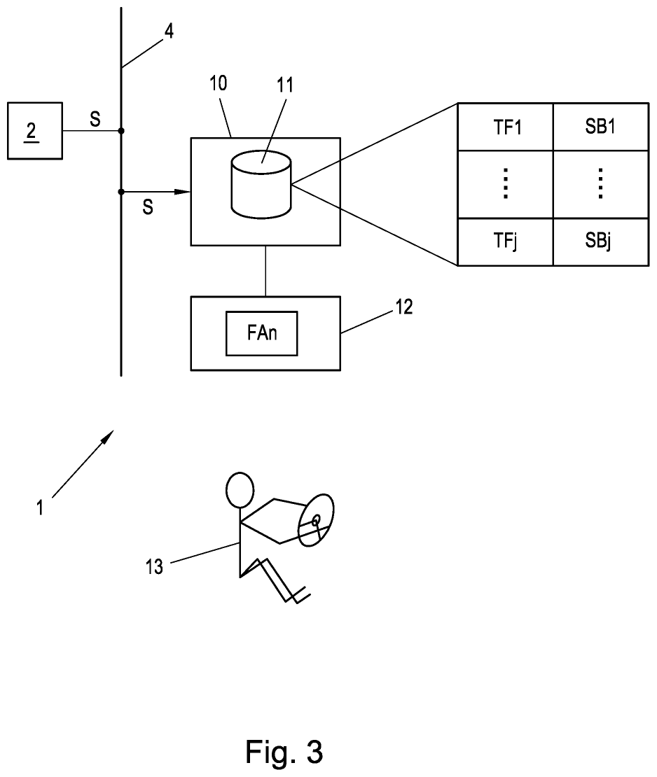

FIG. 3 shows an execution of a test drive according to the invention,

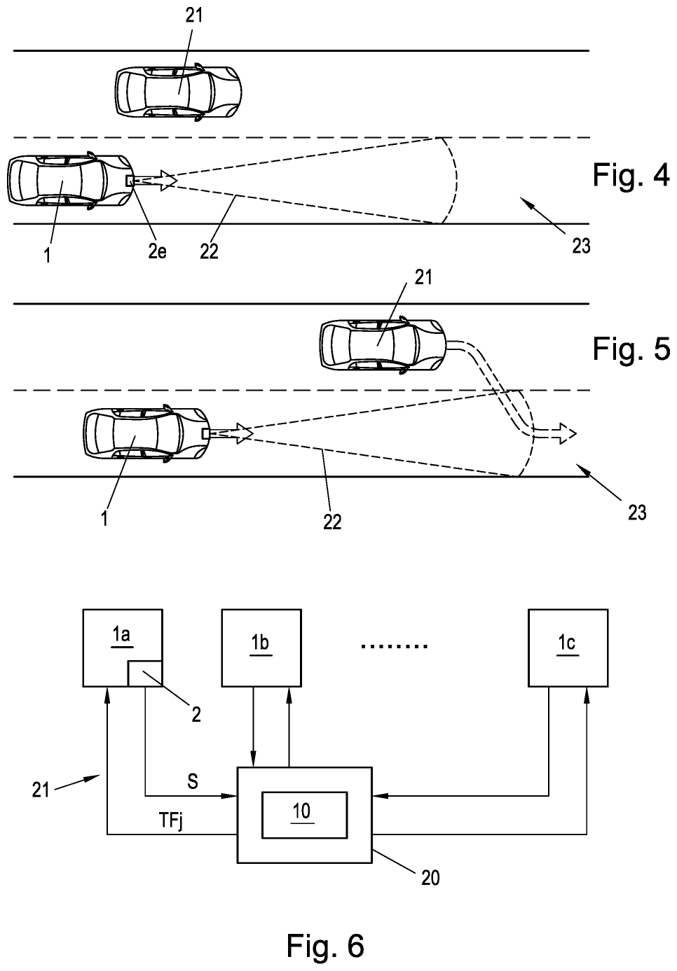

FIGS. 4 and 5 show an example of a possible test case, and

FIG. 6 shows an embodiment having a test center and several test vehicles connected thereto, which each execute a test drive according to the invention.

FIG. 1 shows by way of example a vehicle 1 with various vehicle sensors 2. For illustration, the vehicle sensors 2 are marked with an additional letter in FIG. 1 without limiting the generality, but, if no distinction is required, reference is made in the following description only to vehicle sensors 2. Vehicle sensor 2a is, for example, an acceleration sensor for detecting the driving dynamics (longitudinal acceleration, lateral acceleration, lift acceleration, roll rate, pitch rate, and/or yaw rate) of the vehicle 1. Further vehicle sensors 2 can also be provided for detecting the driving state, such as speed sensors or torque sensors on the drive train and/or on the wheel, etc. Such sensors detect a driving state of the vehicle 1. The vehicle sensor 2b is, for example, a stereo camera, 2c a rain sensor, 2d a radar sensor (front and rear), 2e a lidar sensor (front and rear), 2f an ultrasonic sensor (front and rear), and 2g an ultrasonic sensor (left and right). Likewise, vehicle sensors 2 for detecting pedestrians, road type (freeway, country road, city) or road topology (slope, inclination, curve) (both, for example, by GPS and digital map data), traffic signs, etc., can be provided. Such sensors detect the environment of the vehicle 1. However, a vehicle 1 can naturally also have fewer, additional, or other vehicle sensors 2 than shown by way of example in FIG. 1. For the invention, the configuration of the vehicle 1 with vehicle sensors 2 is not important; rather, all that is decisive is that the vehicle 1 have at least one vehicle sensor 2 which provides a sensor signal S. The sensor signal S represents the measured variable and can be present in any form, e.g., digital or analog, varying sensor value range, etc.

The sensor signals S of the vehicle sensors 2 are sent to a control device 3, where the sensor signals S are evaluated. The control device 3 can then set certain actions via vehicle actuators (not shown in FIG. 1 for reasons of clarity). The vehicle actuators act, for example, upon the vehicle brake, the vehicle steering, the vehicle drive, the vehicle light, the windscreen wipers, or form a signaling device (optical, acoustic, tactile) for the driver. Apart from that, other vehicle actuators which act upon the vehicle 1 or the driver of the vehicle 1 are of course also possible. The configuration of the vehicle 1 with vehicle actuators is not important for the invention.

The sensor signals S of the provided vehicle sensors 2 can be transmitted directly to a control device 3 or via a vehicle bus. Mixed transmissions are also conceivable. FIG. 1 shows a single control device 3. However, a plurality of control devices are usually provided in a vehicle, each of which has different tasks and can also interact—for example, a control device for traction control and a brake control unit. The control device 3 in FIG. 1 is thus symbolic of one or more control devices. A control device 3 is usually designed as a microcontroller having corresponding control software installed and executed thereon. The specific configuration of the control device 3 is also irrelevant to the invention.

Using the test vehicle 1, a test driver 13 is to complete a test drive on a travel route, e.g., a street (city, country, freeway) or a test route on a test property, and in this course execute at least one predetermined test case TF. A test case TF consists of a plurality n>1 of defined, successive test steps TSn, which are to be processed according to the specifications of the test case TF, as indicated in FIG. 2. The test steps TSn do not necessarily have to be provided in series, as shown in FIG. 2, but, instead, several branches could also be provided via defined queries of conditions, in each case having a number of test steps to be carried out in succession. Each test step TSn contains a defined driving instruction FAn for the test driver 13, which the test driver 13 has to implement on or with the test vehicle 1. A driving instruction FAn can, for example, be the instruction to increase or decrease the speed to a target value, to engage another gear, to change a lane, to perform a steering movement, to activate or deactivate a specific vehicle function, etc. A driving instruction FAn can also contain several sub-instructions—for example, acceleration to target speed and lane change.

A defined time span can be provided between individual test steps TSn. However, the next test step TSn can also be displayed only when the previous test step TSn-1, or another defined condition, has been completed. The defined condition can be a specific vehicle state, e.g., reaching a certain speed, and/or a specific environment state of the test vehicle 1—for example, a distance from a vehicle traveling in front. The vehicle state and/or the environment state can be detected by the at least one vehicle sensor 2. If a test step TSn is not completed, then the execution of the test case TF can be interrupted, or attempts can be made to repeat the test step TSn. A test step TSn is not completed, for example, if a certain condition for the next test step TSn+1 is not reached, or if the next test step TSn+1 does not start within a certain period of time.

Using a test case TF, a specific driving maneuver which is to be carried out by the test driver 13 can thus be carried out. A driving maneuver can, for example, be an overtaking maneuver of another vehicle, an approach to a vehicle traveling in front, a specific speed profile of the vehicle, driving through an intersection with traffic lights, etc. There are no limits here, and any conceivable driving maneuver of a test vehicle 1 could be carried out using a test case TF.

During carrying out of a test case TF, at least one sensor signal S is detected using at least one vehicle sensor 2, usually also stored, and evaluated for the test to be executed. The evaluation can take place online during the test drive, and the result of the evaluation can also be displayed to the test driver 13 during the test drive. The test driver 13 thus receives feedback on whether the test case has been successfully completed. However, the at least one sensor signal S can also be stored for a later offline evaluation.

A number j 1 of test cases TFj to be carried out is defined for the test drive. Usually, there are a plurality of different test cases TFj which are to be completed. In order to support the test driver 13 during the completion of at least one test case TF and to make test cases easier to complete with different traffic situations in the surroundings of the test vehicle 1, according to the invention, the procedure is as follows, with reference to FIGS. 2 and 3.

A start condition SBj is defined for each stored test case TFj. The start condition SBj defines a specific predetermined vehicle state, i.e., a driving state and/or an environment state, of the test vehicle 1, which is defined by at least one sensor signal S. Whether one of the start conditions SBj corresponds to a current vehicle state can be determined on the basis of the at least one sensor signal S.

A test unit 10 is provided in the test vehicle 1 (FIG. 3). The test unit 10 can be designed as processor-based hardware, e.g., as a computer, microcontroller, smartphone, tablet computer, etc., on which the test software, which is executed on the hardware, is installed.

The test unit 10 has a memory 11, which can be integrated into the test unit 10 or can be external. In the memory 11, the possible test cases TFj are stored in each case with the associated start condition SBj. The test unit 10 receives the at least one sensor signal S from the at least one vehicle sensor 2. For this purpose, the test unit 10 can be directly connected to a vehicle sensor 2, or the test unit 10 receives the sensor signal S from a control device 3 of the test vehicle 1, or the test unit 10 is connected to a vehicle bus 4 of the test vehicle 1, via which the sensor signal S is transmitted (as indicated in FIG. 3), and reads the sensor signal S from the vehicle bus 4. Of course, sensor signals S of different vehicle sensors 2 can be transmitted to the test unit 10 in various ways. In addition, there can also be other methods of transmitting a sensor signal S. The specific type of transmission of the sensor signal S to the test unit 10 is irrelevant to the invention.

During the travel of the test vehicle 1, the test unit 10 checks continuously (usually in predetermined time steps), on the basis of the transmitted at least one sensor signal S, whether a current vehicle state represented by the sensor signal S corresponds to a start condition SBj of one of the stored test cases TFj.

If the start condition SBj corresponds to a current vehicle state, the test unit 10 can display this circumstance to the test driver 13 on a user interface 12. The test driver 13 can then start carrying out this test case TFj—for example, via the user interface 12 of the test unit 10. The user interface 12 can have optical, acoustic, and/or tactile input and output units, and can also comprise several components for input and output. One possible embodiment of the user interface 12 is in the form of a touchscreen having a loudspeaker and microphone (e.g., as in a tablet computer). Another possible embodiment is in the form of a voice input and voice output. Of course, any other embodiments are also conceivable—for example, having displays, buttons, knobs, rotary knobs, keyboard, mouse, joystick, etc. If a start condition SBj corresponds to a current vehicle state, the test unit 10 can, however, also automatically start the test case TFj associated with the start condition SBj and display this to the driver via the user interface 12. If a test case TFj has been started, the test driver 13 then receives the driving instructions FAnj of the test steps TSnj for the test case TFj—preferably via the user interface 12—and can then complete the test according to the specifications of the test case TFj. The test steps TSnj—specifically, the driving instructions FAnj for the test steps TSnj—are transmitted to the test driver for optical, acoustic, or tactile perception.

If, as is usual, several test cases TFj are stored in the memory 11 for the test drive, it can be the case that the start conditions SBj of different test cases TFj simultaneously correspond to one current vehicle state. In this case, all these test cases TFj can be offered to the test driver 13, from which he can select one which is then started and completed. However, it may also be the case that the test cases TFj are provided with a priority. For example, important test cases TFj or rarely occurring test cases TFj may have a high priority, and frequently occurring test cases TFj may have a low priority. However, the priority can of course also be assigned according to other criteria. The priority can be stored with the test cases TFj in the memory unit 11 and read out. The different test cases TFj can then be offered to the test driver 13 in a sorted manner according to the priority. This can support the test driver 13 in the selection of the test case TFj. However, the test unit 10 can also automatically select and start the test case TFj to be completed on the basis of the priority—for example, by the test case TFj having the highest priority being automatically started. If an automatic selection is not possible, the test driver 13 can make a selection. The priorities of the test cases TFj can be configured before the start of the test.

In particular, the test cases TFj for which another road user is necessary can also be identified very easily, without this other road user having to be simulated by a second test vehicle in the course of execution of the test. Instead, the real road traffic is used, and it is checked whether, due to the current traffic situation, which can be detected for example via an environment sensor, a certain test case TFj results.

During the test drive using the test vehicle 1, test cases TFj which would be possible due to the current vehicle state (driving state and/or environment state) are thus identified by the test unit 10 on the basis of the sensor signal S and the start condition SBj. Therefore, various test cases TFj can be completed during the test drive.

In order to suppress a possible, but not performed, test case TFj, a stop condition can also be defined for a test case TFj. This can simply be a certain stop time after which the test case TFj is removed again from the possible test cases TF to be completed. However, a specific sensor signal S and a condition associated therewith that is specified for the test case TFj can also be used for the stop condition—for example, too great a distance from a vehicle traveling in front.

The procedure according to the invention is described on the basis of a specific embodiment with reference to FIGS. 4 and 5.

FIG. 4 shows a two-lane roadway (freeway or country road) as the travel route 23 along which the test vehicle 1 is moved in the direction of travel (indicated by the arrow) by a test driver 13. On the test vehicle 1, a vehicle sensor 2—in this case, a combination of radar sensor and a stereo camera—is arranged, having a defined sensor region 22 in front of and to the side of the test vehicle 1. The sensor region 22 indicates the range in which the vehicle sensor 2 responds. The vehicle sensor 2 can provide, for example, a sensor signal S for a distance alert system, a distance control system, or an adaptive speed control system of the test vehicle 1. In addition to the test vehicle 1, another vehicle 21 is driving as a road user in normal road traffic. In FIG. 5, this traffic situation is shown a short time period later. Here, the further vehicle 21 changes lane in front of the test vehicle 1 and enters the lane on which the test vehicle 1 is traveling (indicated by the arrow in FIG. 5). If the vehicle 21 enters the sensor range of the vehicle sensor 2 (radar plus camera) of the test vehicle 1 during this driving maneuver, the vehicle sensor 2, and thus a vehicle assistance system linked thereto, responds.

A test case TF could thus be defined as follows:
Start condition SB: A vehicle enters the sensor range of the vehicle sensor of the test vehicle, and there was previously no vehicle in the sensor range.
Test step TS1: Acceleration of the test vehicle in order to reduce the distance between the test vehicle and the vehicle traveling in front, until distance control responds.
Test step TS2: Delay of the test vehicle in order to increase the distance between the test vehicle and the vehicle traveling in front, until distance control becomes inactive.
Stop condition: Distance control system is deactivated by the test driver or distance control system becomes inactive, or a defined time period after detection of the start condition has elapsed without the test step TS1 being started or terminated.

Such a test case TF could still be refined as desired. For example, test cases TFj could be differentiated by taking into account test case parameters. For example, the distance at which the vehicle 21 changes lanes in front of the test vehicle 1, or the relative speed at which the two vehicles 1, 21 move relative to one another, could be used as the test case parameter. Depending upon the test case parameters present, a specific test case TFj could then be selected. Tolerance ranges for certain test case parameters, such as distance or relative speed, can also be defined. Such tolerance ranges can also be stored for the start condition SBj. Further sensor signals of other vehicle sensors 2 can also be consulted for determining the test case parameters.

If a start condition SBj has been detected on the basis of the current sensor signal S, an executed test case TFj can be made therefrom, in that the test driver 13 controls the test vehicle 1 according to the test steps TSn, defined in the test case TFj which is associated with the start condition SBj, using the driving instructions FAn. Thus, a great many different test cases TFj can be tested during normal travel of the test vehicle 1 on a normal road with normal traffic. If at all, there are only a few test cases that have to be tested using a second test vehicle with a second test driver or with a special test setup. This considerably simplifies the execution of test drives using a test vehicle 1.

It is also possible that the successful completion of a test case TFj by the test vehicle 1 is transmitted to a defined test center 20 during the test drive, where further evaluations are then possible, if necessary.

Various test cases TFj can be defined in advance and stored in the memory 11 of the test unit 10. Before the test drive, certain test cases TFj can also be selected for the test drive—for example, all test cases TFj relating to a specific vehicle assistance system. All other test cases are then not taken into account during the test drive.

It is also conceivable for the test unit 10 not to be arranged with the memory unit 11 in the test vehicle 1, but in a test center 20 which is in data communication with the test vehicle 1 via a data connection 21—for example, a Universal Mobile Telecommunications System (UMTS) connection. This is shown, for example, in FIG. 6, in which several test vehicles 1a, 1b, 1c are connected to a test center 20 via a data connection. In FIG. 6, the test vehicles are differentiated by letters only for the purpose of illustration. In this case, the at least one sensor signal S of the at least one vehicle sensor 2 is transmitted via the data connection to the test unit 10, and the start condition SBj is checked by the central test unit 10. The remainder can proceed as described above. In this case, a test case TF selected by the test unit 10 or the test driver 13, having the test steps TSn and test instructions TAn, can be transmitted from the test unit 10 to the test vehicle 1, e.g., to the user interface 12, and displayed there for execution. It is irrelevant in this connection whether an entire test case TFj is transmitted, or individual test steps TSn of a test case TFj. Alternatively, the test cases TFj can also be stored in the test vehicle 1 and be called up via the test unit 10 in the test center 20.

A sensor signal S recorded during the execution of the test case TF can either be recorded and/or evaluated in the test vehicle 1, or can, for evaluation, be transmitted to the central test unit 10 in the test center 20 via the data connection 21.

A central test unit 10 has the advantage that, as a result, several test vehicles 1 can be traveling at the same time and can be in data connection with the test unit 10 for execution of test cases TFj. Thus, more test cases TFj can be completed in a shorter time. The test unit can also provide a test vehicle 1 with the instruction to drive in a certain environment, e.g., in a city or on a freeway, in order to provoke associated test cases TFj—for example, those which have not yet been successfully completed. In this way, entire test fleets consisting of a plurality of test vehicles 1 can be operated.

During the execution of a test case TFj, at least one sensor signal S of at least one vehicle sensor 2 is detected. However, this vehicle sensor 2 does not have to be the same vehicle sensor 2 that was used for the start condition SBj of the test case TFj or for any stop condition of the test case TFj. On the basis of the at least one sensor signal S detected during the execution of the test case TFj, it can be determined on the basis of predetermined evaluation criteria whether a test step TSn, and thus ultimately also the test case TFj, has been successfully completed or not. This evaluation can take place online during the test drive, or, only afterwards, offline. It is also possible to evaluate for success certain test cases TFj online during the test drive, and others offline.

Test cases TFj already completed can also be deleted from the list of test cases to be completed with the test drive. It is also possible to take into account whether a certain test case TFj is to be completed more than once, due to the desired test coverage. The test case TFj is then only deleted from the list of test cases to be executed when the predetermined number of successful executions (which can also be different for different test cases) has been reached. With the deletion of a test case TFj, the start conditions SBj of the deleted test case TFj are also no longer checked during the execution of the test drive.

1. A method for executing a test drive with at least one test vehicle, comprising:
moving the test vehicle by a test driver along a travel route, wherein a plurality of test cases are stored in a memory unit, and each test case is defined as a sequence of test steps which are to be executed by the test driver while carrying out the test case;
completing at least one of said stored test cases by the test driver during the test drive, wherein for each test case, a start condition is defined in dependence of at least one sensor signal of a vehicle sensor of the test vehicle and stored in the memory unit together with the associated test case, wherein each start condition defines a particular vehicle state;
recording at least one sensor signal that represents a current vehicle state with at least one vehicle sensor during the test drive, wherein the at least one sensor signal is transmitted to a test unit, wherein the test unit reads out the start condition of at least one stored test case from the memory unit, and, during the test drive, the test unit checks whether the vehicle state stored for the read-out start condition and the current vehicle state represented by the recorded sensor signal match, and wherein, if said states match, the test driver completes the test case associated to the read-out start condition, in that said test case is started, and the test driver is provided with the test steps defined in this test case for attention, and the test driver performs these test steps.

2. The method according to claim 1, wherein the test unit reads out the start conditions of several stored test cases from the memory unit, and the test unit checks, during the test drive, whether any of the vehicle states stored for the read-out start conditions and the current vehicle state represented by the detected sensor signal match, wherein in the event of a match, the test driver completes the test case associated with this matching start condition, and wherein said test case is started, and the test driver is provided with the test steps defined in this test case for attention, and the test driver performs these test steps.

3. The method according to claim 1, wherein, in the case of a match, the test case is automatically started by the test unit, or wherein the test case is proposed to the test driver from the test unit for execution, and the test driver starts the test case.

4. The method according to claim 1, wherein the test unit reads out the start conditions of several stored test cases from the memory unit, and, during the test drive, the test unit determines all test cases whose associated vehicle states stored as a start condition match the current vehicle state represented by the detected sensor signal, wherein all of these matching test cases are proposed to the test driver by the test unit, and one of these test cases is selected and started by the test driver wherein the test driver completes the started test case, wherein the test steps defined in the started test case are provided to the test driver for attention, and the test driver performs these test steps.

5. The method according to claim 1, wherein the test unit reads out the start conditions of several stored test cases from the memory unit, and, during the test drive, the test unit determines all test cases whose associated vehicle states stored as a start condition match the current vehicle state represented by the detected sensor signal, wherein the test unit selects and starts one of the matching test cases on the basis of a predetermined prioritization of the test cases, wherein the test driver completes the started test case, and wherein the test steps defined in the started test case are displayed to the test driver, and the test driver performs these test steps.

6. The method according to claim 1, wherein, when carrying out the test drive, a completed test case is deleted after completion or after a predetermined multiple completion from the plurality of test cases in the memory unit.

7. The method according to claim 1, wherein the test unit is arranged in the test vehicle.

8. The method according to claim 1, wherein the test unit is arranged in a test center which is in data connection with the test vehicle.

9. The method according to claim 8, wherein the test unit in the test center is in data connection with at least one further test vehicle for executing a test drive, wherein the at least one further test vehicle is moved along a travel route by a further test driver.

10. A system for executing a test drive, comprising:
at least one test vehicle that is moved along a travel route by a test driver;
a memory unit in which a plurality of test cases are stored, and each test case is defined as a sequence of test steps which the test driver executes when carrying out the test case, and the test driver completes at least one of these stored test cases during the test drive, wherein a start condition, depending upon at least one sensor signal of a vehicle sensor of the test vehicle, is defined and stored in the memory unit for each test case, wherein each start condition defines a specific vehicle state, wherein at least one vehicle sensor is provided on the test vehicle, which sensor detects at least one sensor signal, representing a current vehicle state, during the test drive, and a test unit is provided, to which the at least one vehicle sensor transmits the at least one sensor signal, wherein the test unit reads out the start condition of at least one stored test case from the memory unit, and the test unit checks, during the test drive, whether the vehicle state stored for the read-out start condition and the current vehicle state represented by the detected sensor signal match, and wherein, in the event of a match, the test case assigned to the read-out start condition starts, and the test driver completes this test case, wherein the test steps defined in this test case can be provided to the test driver for attention on a user interface, and the test driver carries out these test steps.

11. The system according to claim 10, wherein the test unit is arranged in the test vehicle, or the test unit is arranged in a test center which is in data connection with the test vehicle.
